(19) United States
(12) Patent Application Publication
(10) Pub. No.: US 2016/0142544 A1
(43) Pub. Date: May 19, 2016

(54) APPARATUS AND METHOD FOR CUSTOMER INTERACTION SERVICE

(71) Applicant: Electronics and Telecommunications Research Institute, Daejeon (KR)

(72) Inventors: Hyo-Jung OH, Daejeon (KR); Hyun-Ki KIM, Daejeon (KR); Pum-Mo RYU, Daejeon (KR); Yong-Jin BAE, Daejeon (KR); Chung-Hee LEE, Daejeon (KR); Soo-Jong LIM, Daejeon (KR); Joon-Ho LIM, Daejeon (KR); Myung-Gil JANG, Daejeon (KR); Mi-Ran CHOI, Daejeon (KR); Jeong HEO, Daejeon (KR)

(21) Appl. No.: 14/932,248

(22) Filed: Nov. 4, 2015

(30) Foreign Application Priority Data
Nov. 19, 2014 (KR) 10-2014-0161815

(51) Int. Cl. H04M 3/51; G10L 25/63; G10L 25/54; H04M 3/42

(52) U.S. Cl. CPC H04M 3/5175; H04M 3/42221; G10L 25/63; G10L 25/54

(57) ABSTRACT

An apparatus and method for customer interaction service is provided. The apparatus for customer interaction comprises a customer interaction information DB configured to map voice of customer(VOC) with customer interaction information responding to the VOC by a service provider and store the result; a VOC collecting unit configured to collect VOC in a text or voice form; a VOC analyzing unit configured to extract target texts to be analyzed from the collected VOC and analyze the extracted text to provide analysis result including the subject of VOC; an interaction information searching unit configured to search VOC related to the collected VOC from the customer interaction information DB by using the analysis result; and a response providing unit configured to determine suitability of each customer interaction information related to the collected VOC to provide the best response to the customer based on the determined suitability.

### CROSS REFERENCE TO RELATED APPLICATION

This application claims the benefit of Korean Patent Application No. 10-2014-0161815, filed on Nov. 19, 2014, entitled “Apparatus and method for customer interaction service”, which is hereby incorporated by reference in its entirety into this application.

### BACKGROUND OF THE INVENTION

1. Technical Field

The present invention relates to an apparatus and a method for customer interaction service.

2. Description of the Related Art

Customer interaction information means bidirectional information(voice of customer (hereinafter referred to as VOC)-interaction information) between customer and company. VOC becomes a very important factor to make decisions for business and technologies relating thereto have been developed for customers' satisfactions and service qualities. However, most of current services are limited to processing VOC oriented with call-centers. Most of developing technologies include converting and processing collected VOC in the voice form to in the text form or collecting, storing and managing VOC.

KR Patent Publication No. 10-2012-0018616 discloses a process for providing VOC services which comprises: collecting VOC information as text message; transmitting the collected VOC information to a response system as a message by a terminal; extracting and storing VOC information by a responding system received the message; and transmitting solution plan information corresponding to the extracted VOC information to the terminal through the communication between the terminal and the response system. This is a process only to store received VOC and provide a response resolved through a counselor back to a user terminal.

KR Patent Publication No. 10-2012-0087223 discloses outputting condition of customer's complaints as an alarm by analyzing keywords for collected VOC using a text mining technology, sorting keyword frequency and analyzing patterns.

KR Patent Publication No. 10-2012-0047147 discloses a client dissatisfaction prediction method by extracting counseling content for collected VOC using a text mining technology and predicting counseling numbers to be caused by referring to the number of existing counseling records. This is a prediction method only based on keywords and frequency of existing counseling records.

### PRIOR ART

KR 2012-0018616 A 2012.03.05

KR 2012-0087223 A 2012.08.07

KR 2012-0047147 A 2012.05.11

### SUMMARY OF THE INVENTION

The present invention is to provide an apparatus and method for customer interaction services which is able to analyze bidirectional information including VOC and interaction information corresponding to the VOC which is interacted by company to a user and manage the collected VOC symmetrically and continuously to provide the best solution to the VOC based on existing VOC interaction history.

According to an aspect of the present invention, there is provided an apparatus for customer interaction services.

An apparatus for customer interaction services according to an embodiment of the present invention comprises a customer interaction information DB configured to map voice of customer(VOC) with customer interaction information responding to the VOC by a service provider and store the result; a VOC collecting unit configured to collect VOC in a text or voice form; a VOC analyzing unit configured to extract target texts to be analyzed from the collected VOC and analyze the extracted text to provide analysis result including the subject of VOC; an interaction information searching unit configured to search VOC related to the collected VOC from the customer interaction information DB by using the analysis result; and a response providing unit configured to determine suitability of each customer interaction information related to the collected VOC to provide the best response to the customer based on the determined suitability.

The VOC analyzing unit comprises: a preprocessing module configured to perform a preprocessing process to extract texts and metadata of target contents to be analyzed from the collected VOC; a linguistic analysis module configured to perform linguistic analysis through morphological analysis and named entity recognition for the extracted text; an emotion analysis module configured to perform emotion analysis using the result from the linguistic analysis to understand customer intention; a classification module configured to classify the result from the linguistic analysis and the emotion analysis based on classification scheme predetermined by business types; and an extraction module configured to extract a keyword representing the collected VOC from the classified result.

The preprocessing module converts the VOC in the voice form to in the text form by using voice recognition technique.

The linguistic analysis module recognizes issues written in a variety of lexicons, dissatisfaction expressions or inquiry expressions from the extracted text.

The response providing unit comprises: a suitability determination module configured to determine suitability for the customer interaction information mapped to the VOC related to the collected VOC and rank the customer interaction information based on the determined suitability; a selection module configured to select customer interaction information which is above a predetermined criterion rank from the ranked customer interaction information; and a response module configured to perform an automatic response which provides the selected customer interaction information to a customer or a passive response which connects a counselor to a customer.

The response module performs an automatic response when the selected customer interaction information is higher than a predetermined rank threshold and performs a passive response when it is lower.

The apparatus for customer interaction services further comprises a VOC managing unit configured to analyze new VOC received from a customer or analyze difference between new VOC and existing VOC to control VOC analysis methods or VOC response methods.

The VOC managing unit comprises: a statistics managing module configured to estimate and manage statistics of the VOC stored in the customer interaction information DB and the customer interaction information; a monitoring module configured to monitor progresses of the issues derived through the keyword extraction; a risk detecting module configured to determine an issue with high customer's dissatisfaction among the monitored issues as a risk and to report the result to a corresponding service provider; and a feedback reflecting module configured to recommend situational decision plan or reaction plan to the service provider based on the result from the statistics managing module, the monitoring module or the risk detecting module.

The feedback reflecting module adjusts and reviews a predetermined classification scheme to re-perform VOC analysis when new VOC content is a risk which is very different from the customer interaction information stored in the customer interaction information DB or is required for subdivided classification.

The feedback reflecting module recommends reeducation of workers through decision-making of the service provider for a risk related to the response to VOC.

The feedback reflecting module recommends publicity or marketing activities for a risk associated with dissatisfaction due to lack of information.

The feedback reflecting module recommends decision-making related to product improvement for a risk associated with dissatisfaction related to the product.

According to another aspect of the present invention, there is provided a method for customer interaction services which is performed by an apparatus for customer interaction services using a customer interaction information DB configured to map voice of customer(VOC) with customer interaction information responding to the VOC by a service provider and store the result.

A method for customer interaction services according to an embodiment of the present invention comprises: collecting VOC in a text or voice form; extracting target texts to be analyzed from the collected VOC and analyzing the extracted text to estimate analysis result including the subject of VOC; searching VOC related to the collected VOC from the customer interaction information DB by using the analysis result; and determining suitability of each customer interaction information related to the collected VOC to provide the best response to the customer based on the determined suitability.

The step for estimating analysis result comprises: performing a preprocessing process to extract texts and metadata of target contents to be analyzed from the collected VOC; performing linguistic analysis through morphological analysis and named entity recognition for the extracted text; performing emotion analysis using the result from the linguistic analysis to understand customer intention; classifying the result from the linguistic analysis and the emotion analysis based on classification scheme predetermined by business types; and extracting a keyword representing the collected VOC from the classified result.

The step for performing preprocessing process comprises converting the VOC in the voice form to in the text form by using voice recognition technique.

The step for performing linguistic analysis comprises recognizing issues written in a variety of lexicons, dissatisfaction expressions or inquiry expressions from the extracted text.

The step for providing the best response comprises: determining suitability for the customer interaction information mapped to the VOC related to the collected VOC to rank the customer interaction information based on the determined suitability; selecting customer interaction information which is above a predetermined criterion rank from the ranked customer interaction information; and performing an automatic response which provides the selected customer interaction information to a customer or a passive response which connects a counselor to a customer.

The step for performing an automatic response which provides the selected customer interaction information to a customer or a passive response comprises: performing an automatic response when the selected customer interaction information is higher than a predetermined rank threshold and performs a passive response when it is lower.

The method further comprises analyzing new VOC received from a customer or analyzing difference between new VOC and existing VOC to control VOC analysis methods or VOC response methods.

The present invention allows to analyze bidirectional information including VOC and interaction information corresponding to the VOC which is interacted by company to a user and manage the collected VOC symmetrically and continuously to provide the best solution to the VOC based on existing VOC interaction history.

### BRIEF DESCRIPTION OF THE DRAWINGS

FIG. 1 is a schematic view illustrating configuration of an apparatus for customer interaction services according to an embodiment of the present invention.

FIG. 2 is a schematic view illustrating configuration of a VOC analyzing unit according to an embodiment of the present invention.

FIG. 3 is a schematic view illustrating configuration of a response providing unit according to an embodiment of the present invention.

FIG. 4 is a schematic view illustrating configuration of a VOC managing unit according to an embodiment of the present invention.

FIG. 5A and FIG. 5B illustrate analysis result estimated by a VOC analyzing unit according to an embodiment of the present invention.

FIG. 6 illustrates search result of interaction information searching unit according to an embodiment of the present invention.

FIG. 7 is a flowchart illustrating a method for customer interaction service according to an embodiment of the present invention.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents. Throughout the description of the present invention, when describing a certain technology is determined to evade the point of the present invention, the pertinent detailed description will be omitted. The terms used in the description are intended to describe certain embodiments only, and shall by no means restrict the present invention. While such terms as “first” and “second,” etc., may be used to describe various components, such components must not be limited to the above terms. The above terms are used only to distinguish one component from another.

When one element is described as being “connected” or “accessed” to another element, it shall be construed as being connected or accessed to the other element directly but also as possibly having another element in between.

Exemplary embodiments of the present invention will be described below in more detail with reference to the accompanying drawings, in which those components are rendered the same reference number that are the same or are in correspondence, regardless of the figure number.

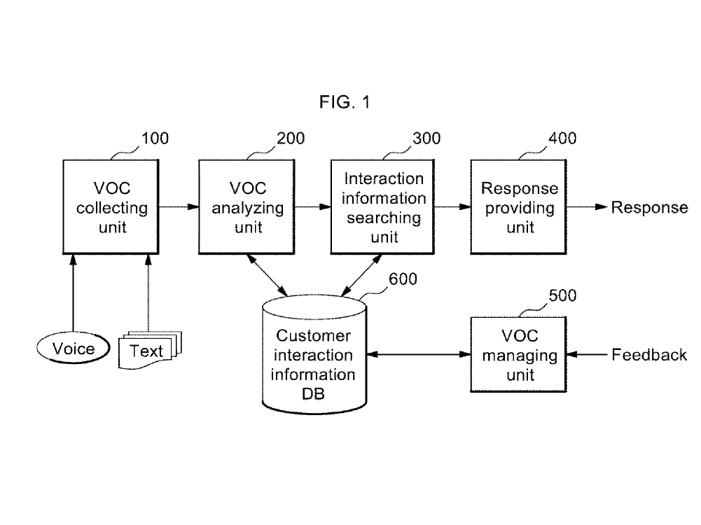

FIG. 1 is a schematic view illustrating configuration of an apparatus for customer interaction services according to an embodiment of the present invention.

Referring to FIG. 1, an apparatus for customer interaction services may include a VOC collecting unit 100, a VOC analyzing unit 200, an interaction information searching unit 300, a response providing unit 400, a VOC managing unit 500 and a customer interaction information DB 600.

The VOC collecting unit 100 may collect VOC in a text or voice form. For example, the VOC collecting unit 100 may collect and stores VOC received from users through website, mobile phone, phone and the like.

The VOC analyzing unit 200 may extract target texts to be analyzed from the collected VOC and analyze the extracted text to provide analysis result including the subject of VOC. The analysis result provided by the VOC analyzing unit 200 may be stored in the customer interaction information DB 600.

The interaction information searching unit 300 may search VOC related to the collected VOC from customer interaction information DB 600 using the analysis result provided by the VOC analyzing unit 200. For example, the customer interaction information DB 600 may map VOC with interaction information corresponding to the VOC which is interacted by company to a user and stores the result. The interaction information searching unit 300 may search customer interaction information related to the collected VOC.

The response providing unit 400 may determine suitability of each customer interaction information related to the collected VOC to provide the best response to the customer based on the determined suitability.

The VOC managing unit 500 may analyze VOC interaction result received from a customer or analyze difference between new VOC and existing VOC to control VOC analysis methods or VOC response methods. For example, the VOC managing unit 500 may control VOC analysis methods or VOC response methods to induce decision-making feedback of the service provider.

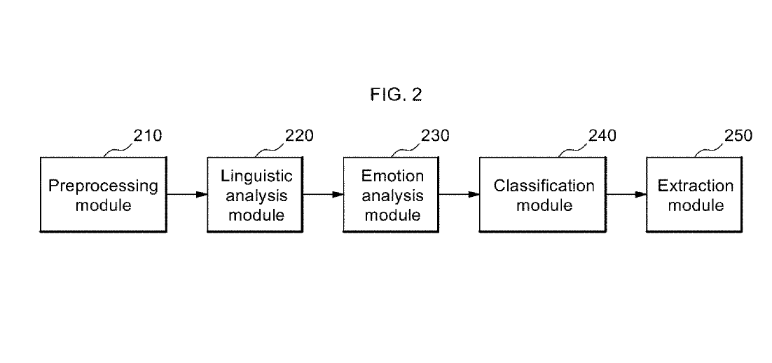

FIG. 2 is a schematic view illustrating configuration of a VOC analyzing unit according to an embodiment of the present invention.

Referring to FIG. 2, the VOC analyzing unit 200 may include a preprocessing module 210, a linguistic analysis module 220, an emotion analysis module 230, a classification module 240 and an extraction module 250.

The preprocessing module 210 may perform a preprocessing process to extract texts and metadata of target contents to be analyzed from the collected VOC. For example, target VOC to be collected may include voice VOC received through landline phones or mobile terminals and text VOC received through bulletin boards, emails and the like. The preprocessing module 210 may convert recorded voice VOC data to text VOC data using voice recognition.

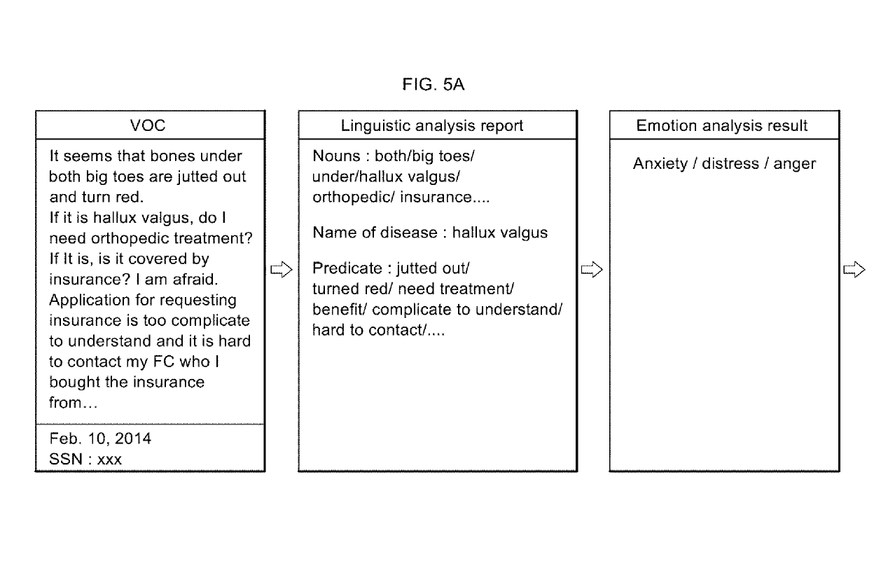

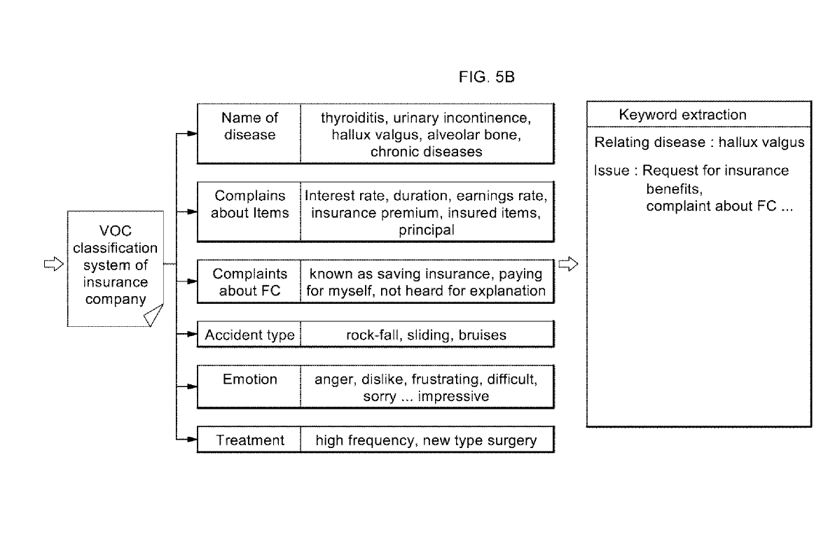

When texts and metadata are extracted, the linguistic analysis module 220 may perform linguistic analysis through morphological analysis and named entity recognition for the extracted texts. The linguistic analysis module 220 may recognize issues written in a variety of lexicons, dissatisfaction expressions or inquiry expressions from the texts. For example, FIG. 5A and FIG. 5B illustrates analysis result estimated by a VOC analyzing unit. FIG. 5A and FIG. 5B shows an example of VOC of an insurance company. As shown in FIG. 5A, the linguistic analysis module 220 may extract nouns and predicates from text VOC through linguistic analysis and recognize dissatisfaction expressions such as difficult understanding, hard to contact and the like, names of diseases such as hallux valgus, issues such as request for insurance benefit, and the like.

The emotion analysis module 230 may perform emotion analysis to understand customers' intention using the recognized result obtained through the linguistic analysis. For example, kinds of emotions may include complaint, distress, anger, admiration, strong feeling and the like and may vary with types of goods or services provided by a company. Further, it may be defined by the company's own standards. As shown in FIG. 5A, the emotion analysis module 230 may extract customer's emotions of anxiety, distress, anger and the like from the result recognized through the linguistic analysis.

The classification module 240 may classify the result obtained from the linguistic analysis and the emotion analysis based on classification scheme predetermined by business types. For example, as shown in FIG. 5B, the classification module 240 may classify and organize the result obtained from the linguistic analysis and the emotion analysis according to VOC classification scheme of an insurance company.

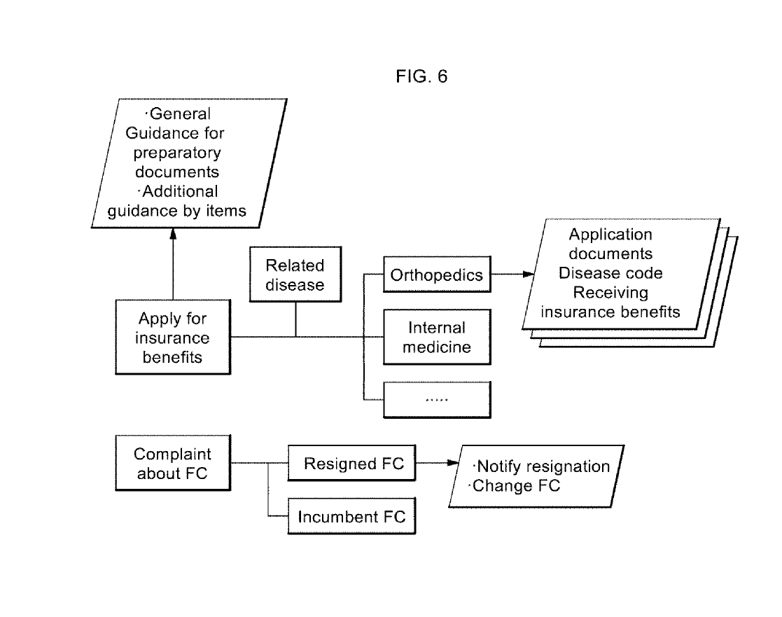

The extraction module 250 may extract keywords representing VOC from the classified result. For example, keywords may be issued words reflecting the user's requirements and keywords extracted from a plurality of VOCs may be issued words classified based on issues. Development of such issues may be monitored by the VOC managing unit 500. For example, as shown in FIG. 5B, the extraction module 250 may extract requests for insurance benefits, FC dissatisfactions and the like as keywords. The interaction information searching unit 300 may search VOCs such as requests for insurance benefits, FC dissatisfactions and the like and customer interaction information from the customer interaction information DB 600 as shown in FIG. 6 which illustrates search result of interaction information searching unit according to an embodiment of the present invention.

Results from each module may be stored in the customer interaction information DB 600.

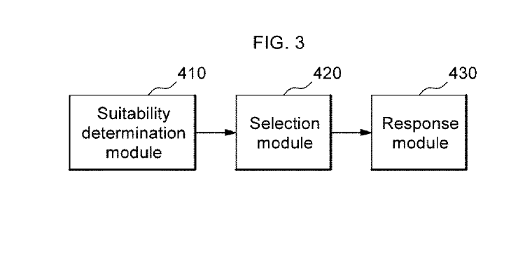

FIG. 3 is a schematic view illustrating configuration of a response providing unit according to an embodiment of the present invention.

Referring to FIG. 3, the response providing unit 400 may include a suitability determination module 410, a selection module 420 and a response module 430.

The suitability determination module 410 may determine suitability of customer interaction information mapped with VOC related to the collected VOC based on a predetermined criteria and rank the customer interaction information based on the determined suitability. Here, the criteria to estimate the suitability may be at least one chosen from customer satisfaction, recency and urgency and may vary with businesses.

The selection module 420 may select customer interaction information which is above a predetermined criterion rank from the ranked customer interaction information.

The response module 430 may perform an automatic response to provide the selected customer interaction information to a customer based on the rank of the selected customer interaction information or perform a passive response to connect a customer to a counselor. For example, the response module 430 may perform an automatic response when the selected customer interaction information is higher than a predetermined rank threshold and perform a passive response when it is lower.

Here, the criterion rank and the rank threshold may be predetermined based on businesses or business environments and may be obtained through the VOC managing unit 500.

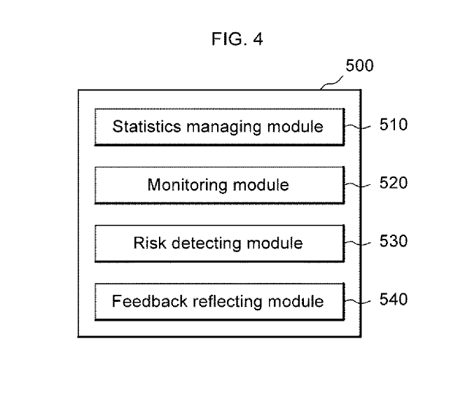

FIG. 4 is a schematic view illustrating configuration of a VOC managing unit according to an embodiment of the present invention.

Referring to FIG. 4, the VOC managing unit 500 may include a statistics managing module 510, a monitoring module 520, a risk detecting module 530 and a feedback reflecting module 540.

The statistics managing module 510 may determine and manage statistics about VOCs stored in the customer interaction information DB 600 and the customer interaction information. For example, the statistics managing module 510 may determine and manage statistics for the number of reported cases, the number of uses per day, per week or per month

The monitoring module 520 may monitor developments of issues derived from the keyword extraction. For example, the monitoring module 520 may analyze trends of products with the highest interest or major dissatisfaction matters over time.

The risk detecting module 530 may distinguish issues with high customer's dissatisfaction which can thus adversely affect its business as risks and report the result to the business provider. For example, issues causing high extreme sensitivity or issues which are reported steadily for a long period of time may be distinguished as risks.

The feedback reflecting module 540 may recommend decision plans or reaction plans based on the results from the statistics managing module 510, the monitoring module 520 or the risk detecting module 530 to the business provider.

For example, when new VOC contents is very different from the customer interaction information stored in the customer interaction information DB 600 or is necessary to be classified in more detail, the feedback reflecting module 540 may adjust and review a predetermined classification scheme to re-analyze the VOC.

In case of a risk relating to response to VOC, the feedback reflecting module 540 may recommend reeducation of workers through company's decision-making process.

In case of a risk relating to dissatisfaction associated with lack of information, the feedback reflecting module 540 may recommend publicity or marketing activities.

In case of a risk relating to dissatisfaction of a certain product, the feedback reflecting module 540 may recommend to perform a decision-making process related to product improvement.

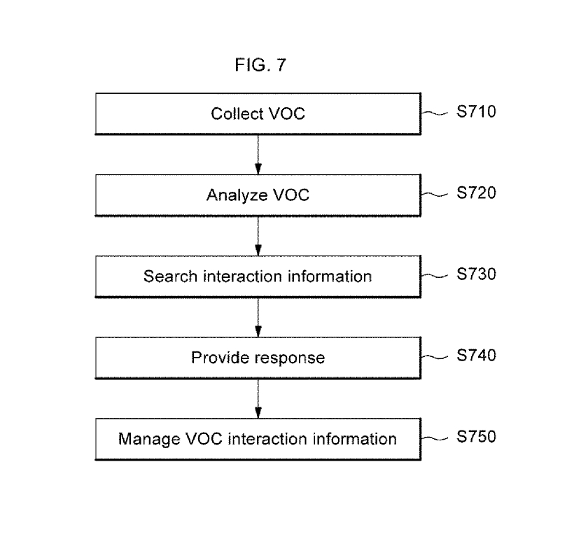

FIG. 7 is a flowchart illustrating a method for customer interaction service according to an embodiment of the present invention.

In S710, the apparatus for customer interaction services may collect VOCs in a text or voice form.

IN S720, the apparatus for customer interaction services may extract target texts to be analyzed from the collected VOCs and analyze the extracted texts to provide analysis result including subjects of the VOCs.

IN S730, the apparatus for customer interaction services may search VOCs related to the collected VOCs from the customer interaction information DB 600 based on the analysis result.

IN S740, the apparatus for customer interaction services may determine suitability of each customer interaction information related to the collected VOCs and provide the best response to a customer based on the determined suitability.

IN S750, the apparatus for customer interaction services may control VOC analysis methods or VOC response methods by analyzing new VOC received from the customer or analyzing difference between the new VOC and existing VOCs.

The exemplary embodiments of the present invention can be implemented by the method which the computer is implemented or in non-volatile computer recording media stored in computer executable instructions. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention. The scope of the present invention should be interpreted by the following claims and it should be interpreted that all spirits equivalent to the following claims fall with the scope of the present invention.

### DESCRIPTION OF REFERENCE NUMERALS

100: VOC Collecting unit

200: VOC Analyzing unit

300: Interaction information searching unit

400: Response providing unit

500: VOC Managing unit

600: Customer interaction information DB

1. An apparatus for customer interaction services comprising:
a customer interaction information DB configured to map voice of customer(VOC) with customer interaction information responding to the VOC by a service provider and store the result;
a VOC collecting unit configured to collect VOC in a text or voice form;
a VOC analyzing unit configured to extract target texts to be analyzed from the collected VOCs and analyze the extracted text to provide analysis result including the subject of VOC;
an interaction information searching unit configured to search VOC related to the collected VOC from the customer interaction information DB by using the analysis result; and
a response providing unit configured to determine suitability of each customer interaction information related to the collected VOC to provide the best response to the customer based on the determined suitability.

2. The apparatus for customer interaction services of claim 1, wherein the VOC analyzing unit comprises:
a preprocessing module configured to perform a preprocessing process to extract texts and metadata of target contents to be analyzed from the collected VOC;
a linguistic analysis module configured to perform linguistic analysis through morphological analysis and named entity recognition for the extracted text;
an emotion analysis module configured to perform emotion analysis using the result from the linguistic analysis to understand customer intention;
a classification module configured to classify the result from the linguistic analysis and the emotion analysis based on classification scheme predetermined by business types; and
an extraction module configured to extract a keyword representing the collected VOC from the classified result.

3. The apparatus for customer interaction services of claim 2, wherein the preprocessing module converts the VOC in the voice form to in the text form by using voice recognition technique.

4. The apparatus for customer interaction services of claim 2, wherein the linguistic analysis module recognizes issues written in a variety of lexicons, dissatisfaction expressions or inquiry expressions from the extracted text.

5. The apparatus for customer interaction services of claim 1, wherein the response providing unit comprises:
a suitability determination module configured to determine suitability for the customer interaction information mapped to the VOC related to the collected VOC and rank the customer interaction information based on the determined suitability;
a selection module configured to select customer interaction information which is above a predetermined criterion rank from the ranked customer interaction information; and
a response module configured to perform an automatic response which provides the selected customer interaction information to a customer or a passive response which connects a counselor to a customer.

6. The apparatus for customer interaction services of claim 5, wherein the response module performs an automatic response when the selected customer interaction information is higher than a predetermined rank threshold and performs a passive response when it is lower.

7. The apparatus for customer interaction services of claim 1, further comprising a VOC managing unit configured to analyze new VOC received from a customer or analyze difference between new VOC and existing VOC to control VOC analysis methods or VOC response methods.

8. The apparatus for customer interaction services of claim 7, wherein the VOC managing unit comprises:
a statistics managing module configured to estimate and manage statistics of the VOC stored in the customer interaction information DB and the customer interaction information;
a monitoring module configured to monitor progresses of the issues derived through the keyword extraction;
a risk detecting module configured to determine an issue with high customer's dissatisfaction among the monitored issues as a risk and to report the result to a corresponding service provider; and
a feedback reflecting module configured to recommend situational decision plan or reaction plan to the service provider based on the result from the statistics managing module, the monitoring module or the risk detecting module.

9. The apparatus for customer interaction services of claim 8, wherein the feedback reflecting module adjusts and reviews a predetermined classification scheme to re-perform VOC analysis when new VOC content is a risk which is very different from the customer interaction information stored in the customer interaction information DB or is required for subdivided classification.

10. The apparatus for customer interaction services of claim 8, wherein the feedback reflecting module recommends reeducation of workers through decision-making of the service provider for a risk related to the response to VOC.

11. The apparatus for customer interaction services of claim 8, wherein the feedback reflecting module recommends publicity or marketing activities for a risk associated with dissatisfaction due to lack of information.

12. The apparatus for customer interaction services of claim 8, wherein the feedback reflecting module recommends decision-making related to product improvement for a risk associated with dissatisfaction related to the product.

13. A method for customer interaction services which is performed by an apparatus for customer interaction services using a customer interaction information DB configured to map voice of customer (VOC) with customer interaction information responding to the VOC by a service provider and store the result, the method comprising:
collecting VOC in a text or voice form;
extracting target texts to be analyzed from the collected VOC and analyzing the extracted text to provide analysis result including the subject of VOC;
searching VOC related to the collected VOC from the customer interaction information DB by using the analysis result; and
determining suitability of each customer interaction information related to the collected VOC to provide the best response to the customer based on the determined suitability.

14. The method of claim 13, wherein the step for estimating analysis result comprises:
performing a preprocessing process to extract texts and metadata of target contents to be analyzed from the collected VOC;
performing linguistic analysis through morphological analysis and named entity recognition for the extracted text;
performing emotion analysis using the result from the linguistic analysis to understand customer intention;
classifying the result from the linguistic analysis and the emotion analysis based on classification scheme predetermined by business types; and
extracting a keyword representing the collected VOC from the classified result.

15. The method of claim 14, wherein the step for performing preprocessing process comprises converting the VOC in the voice form to in the text form by using voice recognition technique.

16. The method of claim 14, wherein the step for performing linguistic analysis comprises recognizing issues written in a variety of lexicons, dissatisfaction expressions or inquiry expressions from the extracted text.

17. The method of claim 13, wherein the step for providing the best response comprises:
determining suitability for the customer interaction information mapped to the VOC related to the collected VOC to rank the customer interaction information based on the determined suitability;
selecting customer interaction information which is above a predetermined criterion rank from the ranked customer interaction information; and
performing an automatic response which provides the selected customer interaction information to a customer or a passive response which connects a counselor to a customer.

18. The method of claim 17, wherein the step for performing an automatic response which provides the selected customer interaction information to a customer or a passive response comprises: performing an automatic response when the selected customer interaction information is higher than a predetermined rank threshold and performs a passive response when it is lower.

19. The method of claim 13, further comprising analyzing new VOC received from a customer or analyzing difference between new VOC and existing VOC to control VOC analysis methods or VOC response methods.
